(19) United States
(12) Patent Application Publication
(10) Pub. No.: US 2025/0132646 A1
(43) Pub. Date: Apr. 24, 2025

(54) HALBACH ARRAY ASSEMBLING METHOD FOR MOTOR ROTOR AND ROTOR FOR MOTOR

(71) Applicants: Hyundai Motor Company, Seoul (KR); Kia Corporation, Seoul (KR)

(72) Inventor: Seongjun Park, Seongnam-si (KR)

(21) Appl. No.: 18/743,679

(22) Filed: Jun. 14, 2024

(30) Foreign Application Priority Data
Oct. 20, 2023 (KR) 10-2023-0140977

(51) Int. Cl. H02K 15/03

(52) U.S. Cl. CPC H02K 15/03

(57) ABSTRACT

A Halbach array assembling method for a motor rotor, and the motor rotor made using that method, can include assembling pre-magnetized magnets, which have magnetization directions, at selected intervals along a tangential direction of a cylindrical rotary body, assembling non-magnetized magnets, which are not magnetized, between the pre-magnetized magnets, placing a magnetization yoke concentric with the non-magnetized magnets and the pre-magnetized magnets, and generating a magnetic field through the non-magnetized magnets and the pre-magnetized magnets using the magnetization yoke to implement a circular Halbach array by magnetizing the non-magnetized magnets.

### CROSS-REFERENCE TO RELATED APPLICATIONS

This application claims priority to and the benefit of Korean Patent Application No. 10-2023-0140977 filed in the Korean Intellectual Property Office on Oct. 20, 2023, the entire contents of which are incorporated herein by reference.

### TECHNICAL FIELD

The present disclosure relates to a Halbach array assembling method for a motor rotor.

### BACKGROUND

In general, a drive motor of an armature includes a stator configured to generate a rotational magnetic field by receiving electrical energy from a battery, and a rotor configured to be rotated by the rotational magnetic field generated by the stator.

The rotor receives electric power and converts the rotational magnetic field generated by the stator into driving energy. The rotor has a structure in which a plurality of magnets (magnetic substances) is arranged around a cylindrical rotary body (rotor hub). The plurality of magnets may be assembled in the form of a circular Halbach array to amplify a magnetic field in a direction toward the stator.

The method of using the Halbach array is advantageous in enhancing the magnetic field of the magnet. However, the Halbach array has a manufacturing problem in that it is difficult to assemble the magnetized magnets to the rotary body because of a drag force that pushes the magnets in opposite directions.

For this reason, in the related art, the magnetized magnets are manually assembled one by one to the rotary body by bonding. However, because the magnets are individually bonded one by one, there is a problem in that a large amount of time is required to cure a bonding agent. In addition, there is also a problem in that the magnets are inadvertently moved by a drag force before the bonding agent is cured, which makes it difficult to optimize a magnetism direction. In particular, to manufacture the rotor of the drive motor, a large number of manual processes are required to magnetize the multipolar magnets having about 12 to 56 poles, and the processes cannot be automated, which causes a problem of deterioration in productivity.

In another related art, there is a method of assembling non-magnetized magnets to a rotary body and then magnetizing the magnets by applying an external magnetic field. However, in the case of this method, a magnetization rate of a portion (e.g., in a tangential direction of the rotary body), where the magnetic field and the magnet are not coincident with each other in positions, decreases at the time of magnetizing the magnets after assembling the magnets. For this reason, this method cannot be applied to industries such as drive motors because of the problem that the magnetization rate decreases in comparison with the method of assembling the magnetized magnet (see FIG. 7A). In addition, the method of assembling the non-magnetized magnets and then magnetizing the non-magnetized magnets is not suitable for the process of manufacturing multipolar rotors because the number of magnetized magnets is limited to 6 to 8 poles.

The above information disclosed in this Background section is only for enhancement of understanding of the background of the present disclosure and therefore it may contain information that does not form the prior art that is already publicly known, available, or in use.

### SUMMARY

The present disclosure relates to a Halbach array assembling method for a motor rotor and a rotor for a motor, and more particularly, to a Halbach array assembling method for a motor rotor and a rotor for a motor, which uses a pre-magnetized magnet preferentially assembled in a tangential direction of a rotary body.

Some embodiments of the present disclosure can provide a Halbach array assembling method for a motor rotor and a rotor for a motor, in which pre-magnetized magnets are preferentially assembled in a tangential direction of a rotary body, and non-magnetized magnets are magnetized after being assembled, which makes it possible to automate a process of assembling a circular Halbach array and shorten a process time without interference caused by a magnetic force.

According to an embodiment of the present disclosure, a Halbach array assembling method for a motor rotor can include assembling pre-magnetized magnets, which have magnetization directions, at predetermined intervals in a tangential direction of a cylindrical rotary body, implementing a rotor by assembling non-magnetized magnets, which are not magnetized, between the plurality of pre-magnetized magnets assembled to the rotary body, and implementing a circular Halbach array by subsequently magnetizing the non-magnetized magnets by generating a magnetic field after fixing a magnetization yoke to the non-magnetized magnets and the pre-magnetized magnets assembled to the rotor.

The assembling pre-magnetized magnets may include applying a bonding agent onto one surface of each of the pre-magnetized magnets, placing the pre-magnetized magnets at corresponding assembling positions by a robot, and curing the bonding agent.

The pre-magnetized magnets may be magnetized in same magnetization directions, and then the magnetization directions may be changed by a single robot, such that the pre-magnetized magnets are alternately assembled clockwise and counterclockwise.

The implementing of the rotor may include applying a bonding agent onto one surface of each of the non-magnetized magnets and simultaneously assembling the non-magnetized magnets by using the robot without waiting time for curing of the bonding agent.

The implementing of the circular Halbach array may include fixing a plurality of air-cored coils of the magnetization yoke, which protrude and are arranged along an inner peripheral surface of a cylindrical main body, at exact positions corresponding to the non-magnetized magnets and magnetizing the non-magnetized magnets in magnetic field directions.

The rotor may be assembled to have any one circular Halbach array structure, among a four-part array, a six-part array, and an eight-part array, depending on the number of poles and parts of the post-magnetized magnets.

The four-part circular Halbach array may include a fifth post-magnetized magnet having a fifth magnetic field (↑) ascending vertically in an outward direction between two pre-magnetized magnets having clockwise and counterclockwise magnetic fields (→ ←), and a sixth post-magnetized magnet having a sixth magnetic field (↓) descending vertically in an inward direction between two pre-magnetized magnets having counterclockwise and clockwise magnetic fields (→ ←).

The six-part circular Halbach array may include a first post-magnetized magnet having a first magnetic field ( [symbol] ) ascending diagonally outward in a clockwise direction and a second post-magnetized magnet having a second magnetic field ( [symbol] ) ascending diagonally outward in a counterclockwise direction between two pre-magnetized magnets having clockwise and counterclockwise magnetic fields (→ ←), and a third post-magnetized magnet having a third magnetic field ( [symbol] ) descending diagonally inward in the counterclockwise direction and a fourth post-magnetized magnet having a fourth magnetic field ( [symbol] ) descending diagonally inward in the clockwise direction between two pre-magnetized magnets having counterclockwise and clockwise magnetic fields (→ ←).

In comparison with the six-part Halbach array, the eight-part circular Halbach array may further include a sixth post-magnetized magnet having a sixth magnetic field (↓) descending vertically in an inward direction between the third post-magnetized magnet having the third magnetic field ( [symbol] ) and the fourth post-magnetized magnet having the fourth magnetic field ( [symbol] ), and a fifth post-magnetized magnet having a fifth magnetic field (↑) ascending vertically in an outward direction between the first post-magnetized magnet having the first magnetic field ( [symbol] ) and the second post-magnetized magnet having the second magnetic field ( [symbol] ).

The rotor may be manufactured as at least one of an inner rotor in which a plurality of magnets is assembled in the form of a Halbach array on an outer peripheral surface of the rotary body, an outer rotor in which a plurality of magnets is assembled in the form of a Halbach array on an inner peripheral surface of the rotary body, and an axial flux rotor.

According to an embodiment of the present disclosure, a rotor for a motor can be manufactured by the above-mentioned Halbach array assembling method for a motor rotor.

According to the embodiment of the present disclosure, the pre-magnetized magnets can be preferentially assembled in the tangential direction of the rotary body, and the non-magnetized magnets can be assembled and then magnetized to implement the circular Halbach array, such that the process of assembling the magnets may be automated without interference caused by the magnetic force/drag force.

The process of assembling the circular Halbach array of the rotor can be automated, and the process of assembling the pre-magnetized magnets in the magnetization direction can be simplified, thereby reducing a time, personnel costs, and facility costs consumed by the manual assembling process.

The pre-magnetized magnets having the magnetization directions can be preferentially assembled in the tangential line of the rotary body, thereby ensuring the magnetization rate of the portion with a low magnetization rate and increasing the magnetization rate by performing magnetic field boosting at the time of magnetizing the non-magnetized magnets.

### BRIEF DESCRIPTION OF THE DRAWINGS

FIG. 1 is a diagram illustrating a Halbach array applied to a rotor for a motor according to an embodiment of the present disclosure.

FIG. 2 is a diagram illustrating a state in which pre-magnetized magnets are assembled to a rotary body according to an embodiment of the present disclosure.

FIG. 3 is a diagram illustrating the pre-magnetized magnets being assembled in a tangential direction of the rotary body, according to an embodiment of the present disclosure.

FIG. 4 is a diagram illustrating a part of a configuration in which non-magnetized magnets are assembled between the pre-magnetized magnets, according to an embodiment of the present disclosure.

FIG. 5 is a diagram illustrating a method of forming magnetism of the Halbach array on the rotor by using a magnetization yoke, according to an embodiment of the present disclosure.

FIG. 6 is a diagram illustrating a magnetic field direction generated by the yoke according to an embodiment of the present disclosure during a magnetization process and illustrating a magnetization direction of the magnetized magnets.

FIGS. 7A and 7B are diagrams illustrating a comparison between magnetization intensity of a magnet magnetized without pre-magnetization in the related art and magnetization intensity of the magnet when the pre-magnetized magnet is assembled in the tangential direction and then magnetized according to an embodiment of the present disclosure, respectively.

FIG. 8 is a diagram illustrating an example of a Halbach array of a rotor for a motor, according to an embodiment of the present disclosure.

FIG. 9 is a diagram illustrating a Halbach array applied to a rotor for a motor according to an embodiment of the present disclosure.

### DETAILED DESCRIPTION OF ILLUSTRATIVE EMBODIMENTS

Hereinafter, an example embodiment of the present disclosure will be described in detail with reference to the accompanying drawings so that those skilled in the technical field to which the present disclosure pertains may easily carry out embodiments of the present disclosure.

Terms used herein are merely for the purpose of describing a specific example embodiment, and not intended to necessarily limit the present disclosure. Singular expressions used herein can include the plural expressions thereof unless the context clearly dictates otherwise. It can be understood that the term “comprise (include)” and/or “comprising (including)” used in the present specification means that the features, the integers, the steps, the operations, the constituent elements, and/or component are present, and the presence or addition of one or more of other features, integers, steps, operations, constituent elements, components, and/or groups thereof are not excluded. The term “and/or” used herein includes any one or all the combinations of listed related items.

Throughout the specification, terms such as “first,” “second,” “A,” “B,” “(a),” “(b),” and other numerical terms may be used herein to describe various elements, and these elements are not necessarily limited by such terms. Such terms can be used for the purpose of distinguishing one constituent element from another constituent element, and the nature, the sequences, or the orders of the constituent elements are not necessarily limited by such terms.

Throughout the specification, when one constituent element is described as being “connected” or “coupled” to another constituent element, it can be understood that one constituent element can be connected or coupled directly to another constituent element, and an intervening constituent element can also be present between the constituent elements. When one constituent element is described as being “connected directly to” or “coupled directly to” another constituent element, it can be understood that no intervening constituent element is present between the constituent elements.

One or more of the following methods or embodiments thereof can be carried out by at least one controller. The term “controller” may refer to a hardware device including a memory and a processor. The memory can be configured to store program instructions, and the processor can be specially programmed to execute the program instructions to perform one or more processes described below in more detail. The controller may control operations of units, modules, components, devices, or the like, as described herein. In addition, it can be understood that the following methods may be carried out by an apparatus including the controller as well as one or more other components, as recognized by those skilled in the art.

Hereinafter, a Halbach array assembling method for a motor rotor according to an example embodiment of the present disclosure will be described in detail with reference to the drawings. In the drawings, arrows may be used to illustrate a direction of a magnetic field for a given magnet.

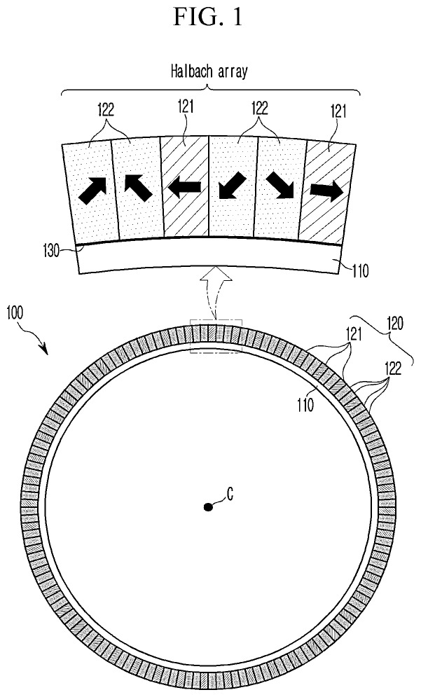

FIG. 1 illustrates a Halbach array applied to a rotor for a motor according to an embodiment of the present disclosure.

With reference to FIG. 1, a rotor 100 for a motor according to an embodiment of the present disclosure can have a cylindrical rotary body 110 and a structure in which a plurality of magnets (magnetic substances) 120 can be assembled in the form of a circular Halbach array in a tangential direction of the rotary body 110 about a rotation axis C. The circular Halbach array of the magnets 120 can have a magnetic structure and characteristics that can amplify a magnetic field of a rotary body 110 toward a stator. Therefore, the Halbach array can serve to improve efficiency of a magnetic circuit by amplifying the magnetic field of the rotor 100.

The rotor 100 according to an embodiment of the present disclosure may be applied to a permanent magnet synchronous motor (PMSM) applied to an electric vehicle (EVx). The motor (e.g., PMSM) may be a radial flux motor or an axial flux motor. Therefore, depending on the type of applied motor (e.g., PMSM), the rotor 100 may be configured as a radial flux rotor, in which a circular Halbach array is formed on an outer peripheral surface of the rotary body 110 about the rotation axis C, or an axial flux rotor in which a circular Halbach array is formed on one surface of the rotary body 110 based on a direction of the rotation axis C.

Hereinafter, for convenience of description, as illustrated in FIG. 1, the rotor 100 will be described with reference to a method of assembling a radial flux rotor that forms a circular Halbach array (e.g., [symbol] → [symbol] [symbol] ← [symbol] ) based on a six-part (pair) magnet 120.

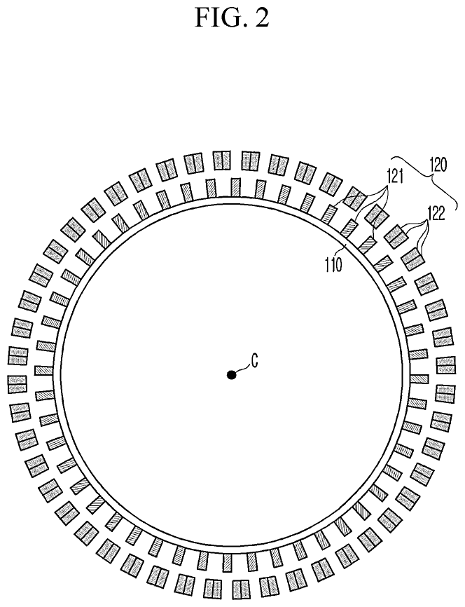

FIG. 2 illustrates a state in which pre-magnetized magnets are assembled to the rotary body according to an embodiment of the present disclosure.

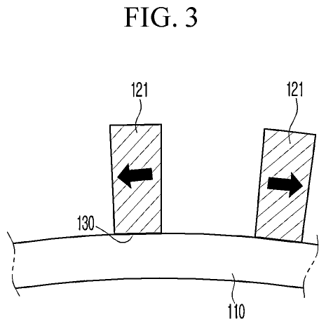

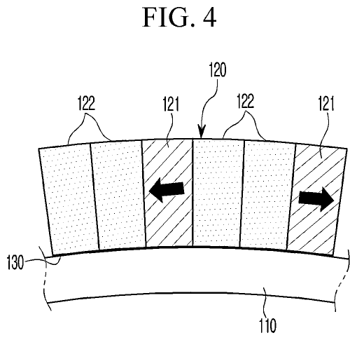

FIG. 3 illustrates the pre-magnetized magnets assembled in the tangential direction of the rotary body according to an embodiment of the present disclosure. FIG. 4 illustrates a part of a configuration in which non-magnetized magnets are assembled between the pre-magnetized magnets.

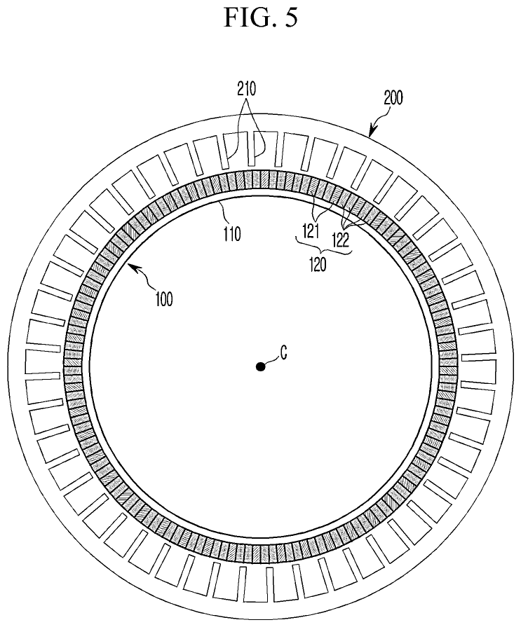

FIG. 5 illustrates a method of forming magnetism of the Halbach array on the rotor by using a magnetization yoke according to an embodiment of the present disclosure.

With reference to FIGS. 2 to 5, a Halbach array assembling method for the rotor 100 for a motor according to an embodiment of the present disclosure includes a first step of preferentially magnetizing a plurality of pre-magnetized magnets 121 having magnetization directions and then assembling the plurality of pre-magnetized magnets 121 at predetermined intervals in the tangential direction of the cylindrical rotary body 110, a second step of implementing the rotor 100 by assembling non-magnetized magnets 122, which are not magnetized, between the plurality of pre-magnetized magnets 121 assembled to the rotary body 110, and a third step of implementing the circular Halbach array by subsequently magnetizing the non-magnetized magnets 122 by generating a magnetic field after fixing a magnetization yoke 200 to the non-magnetized magnets 122 and the pre-magnetized magnets 121 assembled to the rotor 100.

Hereinafter, detailed processes performed in the respective example steps will be described.

The first step can include a step of applying a bonding agent 130 onto one surface of each of the pre-magnetized magnets 121, placing the pre-magnetized magnets 121 at corresponding assembling positions by an assembling apparatus such as an orthogonal robot or an articulated robot, and then curing the bonding agent 130. The assembling apparatus may use a publicly-known technology in which the clamp holds the magnet and transfer the magnet by use of a kinematic motion, for example.

Even though the pre-magnetized magnets 121 are magnetized, the pre-magnetized magnets 121 may be assembled by peripheral magnetism without an interference force.

In addition, with reference to FIG. 3, the pre-magnetized magnets 121 can be assembled in two types of longitudinal or tangential directions including clockwise and counterclockwise directions.

After the pre-magnetized magnets 121 are magnetized in the same magnetization direction, the magnetization directions can be changed by the single assembling apparatus, such that the pre-magnetized magnets 121 are alternately assembled clockwise and counterclockwise. That is, the orientations of the pre-magnetized magnets 121 are identical to each other, but the pre-magnetized magnets 121 are assembled while the magnetization directions (clockwise/counterclockwise), in which the pre-magnetized magnets 121 are assembled after being magnetized, are changed by the single assembling apparatus, thereby simplifying the production facility.

Next, in the second step, the bonding agent 130 can be applied onto one surface of each of the non-magnetized magnets 122, and the non-magnetized magnets 122 can be simultaneously assembled by using an assembling apparatus such as an orthogonal robot or an articulated robot without a waiting time for curing the bonding agent 130.

As in the above-mentioned background art of the present disclosure, the magnetized magnets can be assembled by bonding. In this case, in the related art, because the magnets are inadvertently moved by a drag force before the bonding agent 130 is cured, the magnets cannot be simultaneously assembled, and the magnets need to be assembled one by one after waiting for the curing of the bonding agent 130, which causes a problem in that a large amount of time is required.

In contrast, with reference to FIG. 4, because the non-magnetized magnets 122 according to an embodiment of the present disclosure may be assembled without magnetization, such that no magnetic force/drag force is generated. Therefore, it can be possible to almost simultaneously and automatically assemble the non-magnetized magnets 122 continuously without waiting for the curing of the bonding agent 130. Therefore, it can be possible to reduce a process cycle time by automating the process of assembling the magnets and to efficiently assemble the magnets, thereby improving the product productivity.

Next, in the third step, a plurality of air-cored coils 210 of the magnetization yoke 200, which protrude and are arranged along an inner peripheral surface of a cylindrical main body, can be fixed to exact positions corresponding to the non-magnetized magnets 122, and the non-magnetized magnets 122 can be magnetized in the magnetic field direction.

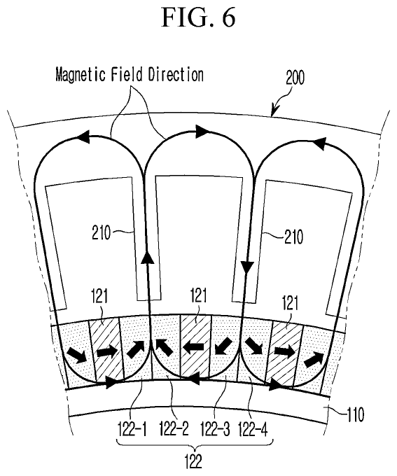

For example, FIG. 6 illustrates a magnetic field direction generated by the yoke according to an embodiment of the present disclosure during a magnetization process and illustrates a magnetization direction of the magnetized magnets.

With reference to FIG. 6, the non-magnetized magnets 122 can be subsequently magnetized in the magnetic field direction generated by the air-cored coils 210 of the magnetization yoke 200 to form post-magnetized magnets 122 (hereinafter, denoted by the same reference numeral as the non-magnetized magnet), and the post-magnetized magnets 122 form the magnetization directions, thereby implementing a six-part Halbach array.

For example, a six-part Halbach array can include, between the two pre-magnetized magnets 121 having the clockwise and counterclockwise magnetic fields (→ ←), a first post-magnetized magnet 122-1 having a first magnetic field ( [symbol] ) ascending diagonally outward in the clockwise direction and a second post-magnetized magnet 122-2 having a second magnetic field ( [symbol] ) ascending diagonally outward in the counterclockwise direction, and can include, between the two pre-magnetized magnets 121 having the counterclockwise and clockwise magnetic fields (→ ←), a third post-magnetized magnet 122-3 having a third magnetic field ( [symbol] ) descending diagonally inward in the counterclockwise direction and a fourth post-magnetized magnet 122-4 having a fourth magnetic field ( [symbol] ) descending diagonally inward in the clockwise direction.

The pre-magnetized magnet 121 according to an embodiment of the present disclosure can be characterized by increasing a magnetization rate of the post-magnetized magnets 122 by performing boosting in a magnetic field direction identical to the magnetic field direction of the magnetization yoke 200 during the post-magnetization process.

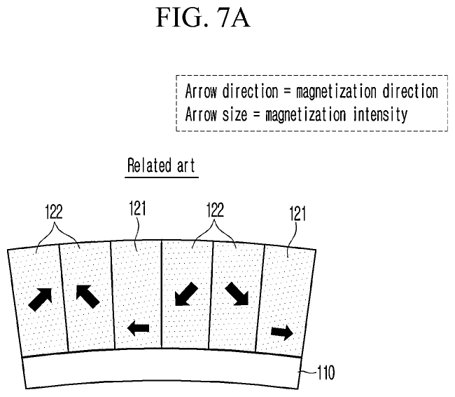

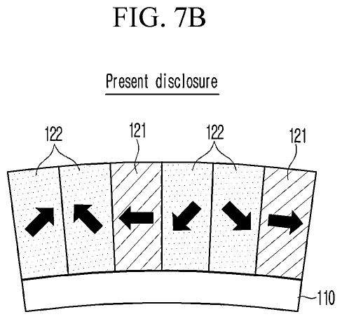

FIGS. 7A and 7B illustrate a comparison between magnetization intensity of a magnet magnetized without pre-magnetization in the related art and magnetization intensity of the magnet when the pre-magnetized magnet is assembled in the tangential direction and then magnetized according to an embodiment of the present disclosure.

Hereinafter, in the drawings, a direction and a size of the arrow can respectively mean a magnetization direction and a magnetization intensity of the magnetized magnet.

With reference to FIG. 7A, in the related art, the non-magnetized magnets are assembled to the rotary body, and then the magnetic field is applied through the magnetization yoke to the non-magnetized magnets to magnetize the non-magnetized magnets without pre-magnetization. For this reason, a magnetization rate (a) of a portion (in the tangential direction of the rotary body), where the magnetic field of the yoke and the magnet are not coincident with each other in positions, can be low. In addition, a magnetization rate (b) of a portion (in the diagonal direction), where the magnetic field direction of the yoke is dispersed during the magnetization process, is also decreased, which can cause a problem of deterioration in overall magnetization performance of the rotor.

In contrast, with reference to FIG. 7B, in the case of the rotor 100 according to an embodiment of the present disclosure, the pre-magnetized magnets 121, which have the magnetization directions formed in the tangential line of the rotary body 110, can be preferentially assembled, thereby ensuring a magnetization rate (100% magnetization) of the portion where the magnetic field and the magnet are not coincident with each other in positions. In addition, it is possible to improve overall magnetization performance of the rotor 100 by boosting the portion (in the diagonal direction), where the magnetic field direction of the magnetization yoke 200 is dispersed during the post-magnetization process, by using the pre-magnetized magnets 121.

While an example embodiment of the present disclosure has been described, the present disclosure is not necessarily limited only to the example embodiment and may be variously modified.

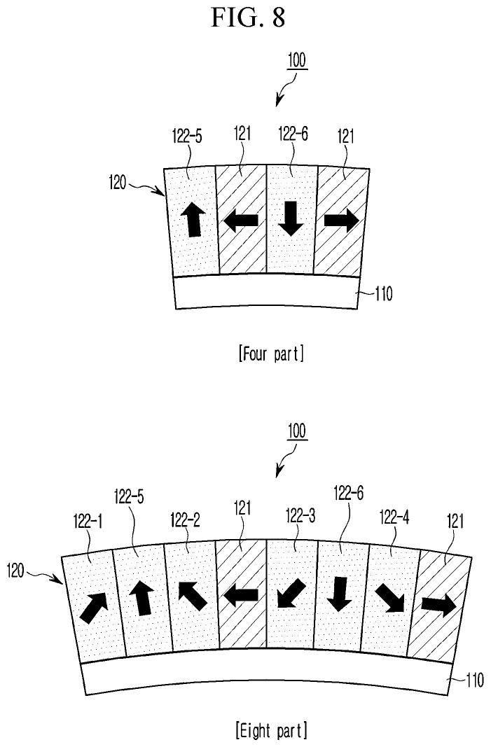

For example, FIG. 8 illustrates an example of a Halbach array of a rotor for a motor according to another embodiment of the present disclosure.

With reference to FIGS. 2-6, the description of an embodiment of the present disclosure described above is focused on the six-part Halbach array, but the embodiment of the present disclosure is not necessarily limited thereto. With reference to FIG. 8, it is possible to manufacture the rotor 100 having a structure with a four-part array or an eight-part array.

The steps of the Halbach array assembling method for the rotor 100 having the structure with the four-part array or the eight-part array are identical to the above-mentioned first to third steps. In the second step, the number of poles and division parts of the post-magnetized magnets 122, which can be assembled between the plurality of pre-magnetized magnets 121, and which can be preferentially magnetized and then assembled to the rotary body 110, may vary.

For example, the four-part Halbach array may include, between the two pre-magnetized magnets 121 having the clockwise and counterclockwise magnetic fields (→ ←), a fifth post-magnetized magnet 122-5 having a fifth magnetic field (↑) ascending vertically in the outward direction, and include, between the two pre-magnetized magnets 121 having the counterclockwise and clockwise magnetic fields (→ ←), a sixth post-magnetized magnet 122-6 having a sixth magnetic field (↓) descending vertically in the inward direction.

Referring to FIG. 8, in comparison with the six-part Halbach array, the eight-part Halbach array may further include the sixth post-magnetized magnet 122-6 having the sixth magnetic field (↓) descending vertically in the inward direction, between the third post-magnetized magnet 122-3 having the third magnetic field ( [symbol] ) and the fourth post-magnetized magnet 122-4 having the fourth magnetic field ( [symbol] ).

The eight-part Halbach array may further include the fifth post-magnetized magnet 122-5 having the fifth magnetic field (↑) ascending vertically in the outward direction, between the first post-magnetized magnet 122-1 having the first magnetic field ( [symbol] ) and the second post-magnetized magnet 122-2 having the second magnetic field ( [symbol] ).

FIG. 8 illustrates a Halbach array of an outer rotor according to an example embodiment of the present disclosure.

The rotor 100 according to an embodiment of the present disclosure has been described on the assumption that the inner rotor is implemented by assembling the plurality of magnets 120 in the form of the Halbach array on the outer peripheral surface of the rotary body 110.

However, with reference to FIG. 8, the rotor 100 according to an embodiment of the present disclosure may be manufactured as an outer rotor in which the plurality of magnets 120 is assembled in the form of the Halbach array on an inner peripheral surface of the rotary body 110.

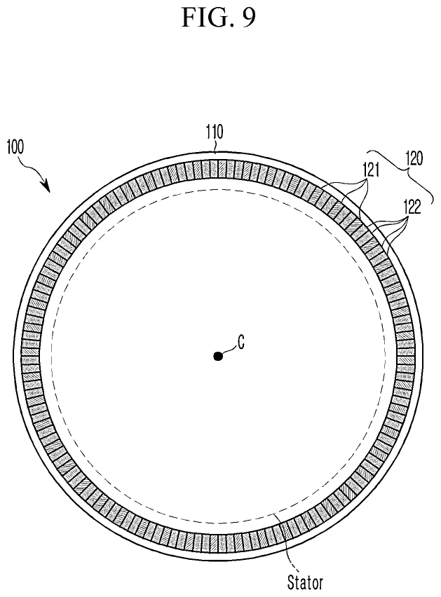

FIG. 9 is a diagram illustrating a Halbach array applied to a rotor for a motor according to an embodiment of the present disclosure. Referring to FIG. 9, the Halbach array can be assembled on an outer rotor configuration in which the stator is located in the center and the rotor with the Halbach array rotates about the stator (rather than within it).

As described above, depending on the type of applied motor (e.g., PMSM), the rotor 100 may be configured as an axial flux rotor in which a circular Halbach array is formed on one surface of the rotary body 110 based on the direction of the rotation axis C.

Because the outer rotor and the axial flux rotor are different only in terms of the assembling positions of the magnets 120, the manufacturing of the axial flux rotor also may be implemented according to an embodiment of the present disclosure.

As described above, according to an embodiment of the present disclosure, the pre-magnetized magnets can be preferentially assembled in the tangential direction of the rotary body, and the non-magnetized magnets can be assembled and then magnetized to implement the circular Halbach array, such that the process of assembling the magnets may be automated without interference caused by the magnetic force/drag force.

Using an embodiment of the present disclosure, the process of assembling the circular Halbach array of the rotor can be automated, and the process of assembling the pre-magnetized magnets in the magnetization direction can be simplified, thereby reducing the time, personnel costs, and facility costs consumed by the manual assembling process.

Using an embodiment of the present disclosure, the pre-magnetized magnets having the magnetization directions can be preferentially assembled in the tangential line of the rotary body, thereby ensuring the magnetization rate of the portion with a low magnetization rate and increasing the magnetization rate by performing magnetic field boosting at the time of magnetizing the non-magnetized magnets.

Embodiments of the present disclosure are not limited to being implemented only by the apparatus and/or method described above. Based on the above-mentioned descriptions of the example embodiments, those skilled in the art to which the present disclosure pertains may easily realize the example embodiments through programs for realizing functions corresponding to the configuration of the example embodiment of the present disclosure or recording media on which the programs are recorded.

Although example embodiments of the present disclosure have been described in detail above, the scope of the present disclosure is not necessarily limited thereto, and the present disclosure can be construed such that many variations and modifications can be made by those skilled in the art using concepts of the present disclosure, which can be claimed in the following claims.

What is claimed is:

1. A method of assembling a Halbach array for a motor rotor, the method comprising:
assembling pre-magnetized magnets, which have magnetization directions, at selected intervals along a tangential direction of a cylindrical rotary body;
assembling non-magnetized magnets, which are not magnetized, between the pre-magnetized magnets;
placing a magnetization yoke concentric with the non-magnetized magnets and the pre-magnetized magnets; and
generating a magnetic field through the non-magnetized magnets and the pre-magnetized magnets using the magnetization yoke to implement a circular Halbach array by magnetizing the non-magnetized magnets.

2. The method of claim 1, wherein the assembling of the pre-magnetized magnets comprises:
applying a bonding agent onto a surface of each of the pre-magnetized magnets;
placing the pre-magnetized magnets at corresponding assembling positions by a robot; and
curing the bonding agent.

3. The method of claim 1, wherein the pre-magnetized magnets are initially magnetized in a same tangential magnetization direction, and wherein the assembling of the pre-magnetized magnets comprises:
flipping some of the pre-magnetized magnets; and
alternately assembling the pre-magnetized magnets in clockwise and counterclockwise tangential magnetization directions by a single robot.

4. The method of claim 1, further comprising:
applying a bonding agent onto a pre-magnetized magnet surface of each of the pre-magnetized magnets;
placing the pre-magnetized magnets at corresponding assembling positions by a robot;
applying the bonding agent onto a non-magnetized magnet surface of each of the non-magnetized magnets;
placing the non-magnetized magnets between the placed pre-magnetized magnets by the robot; and
curing the bonding agent after the placing of the pre-magnetized magnets and the non-magnetized magnets.

5. The method of claim 1, wherein the placing of the magnetization yoke comprises placing
air-cored coils of the magnetization yoke, wherein the air-cored coils protrude radially inwardly and are arranged along an inner peripheral surface of a cylindrical main yoke body at positions corresponding to the non-magnetized magnets.

6. The method of claim 1, wherein the motor rotor is assembled to have a circular Halbach array structure of a four-part Halbach array, a six-part Halbach array, or an eight-part Halbach array, based on a number of poles and parts of post-magnetized magnets.

7. The method of claim 6, wherein the circular Halbach array structure is the four-part Halbach array comprising:
a fifth post-magnetized magnet having a fifth magnetic field ascending vertically in an outward radial direction, wherein the fifth post-magnetized magnet is positioned between two of the pre-magnetized magnets having clockwise and counterclockwise magnetic fields; and
a sixth post-magnetized magnet having a sixth magnetic field descending vertically in an inward radial direction, wherein the sixth post-magnetized magnet is positioned between two of the pre-magnetized magnets having counterclockwise and clockwise magnetic fields.

8. The method of claim 6, wherein the circular Halbach array structure is the six-part Halbach array comprising:
a first post-magnetized magnet having a first magnetic field ascending diagonally outward in a clockwise direction;
a second post-magnetized magnet having a second magnetic field ascending diagonally outward in a counterclockwise direction, wherein the first post-magnetized magnet and the second post-magnetized magnet are together positioned between two of the pre-magnetized magnets having clockwise and counterclockwise magnetic fields;
a third post-magnetized magnet having a third magnetic field descending diagonally inward in the counterclockwise direction; and
a fourth post-magnetized magnet having a fourth magnetic field descending diagonally inward in the clockwise direction, wherein the third post-magnetized magnet and the fourth post-magnetized magnet are together positioned between two of the pre-magnetized magnets having counterclockwise and clockwise magnetic fields.

9. The method of claim 6, wherein the circular Halbach array structure is the eight-part Halbach array comprising:
a first post-magnetized magnet having a first magnetic field ascending diagonally outward in a clockwise direction;
a second post-magnetized magnet having a second magnetic field ascending diagonally outward in a counterclockwise direction;
a third post-magnetized magnet having a third magnetic field descending diagonally inward in the counterclockwise direction;
a fourth post-magnetized magnet having a fourth magnetic field descending diagonally inward in the clockwise direction;
a fifth post-magnetized magnet having a fifth magnetic field ascending vertically in an outward radial direction, wherein the fifth post-magnetized magnet is positioned between the first post-magnetized magnet and the second post-magnetized magnet, wherein the first post-magnetized magnet, the second post-magnetized magnet, and the fifth post-magnetized magnet are together positioned between two of the pre-magnetized magnets having clockwise and counterclockwise magnetic fields; and
a sixth post-magnetized magnet having a sixth magnetic field descending vertically in an inward radial direction, wherein the sixth post-magnetized magnet is positioned between the third post-magnetized magnet and the fourth post-magnetized magnet, and wherein the third post-magnetized magnet, the fourth post-magnetized magnet, and the sixth post-magnetized magnet are together positioned between two of the pre-magnetized magnets having counterclockwise and clockwise magnetic fields.

10. The method of claim 1, wherein the assembling of the pre-magnetized magnets and the assembling the non-magnetized magnets comprises:
placing the pre-magnetized magnets and the non-magnetized magnets on an outer peripheral surface of the cylindrical rotary body to form an inner rotor structure for the motor rotor, and such that the placing of the magnetization yoke is concentrically around and outside of the cylindrical rotary body;
placing the pre-magnetized magnets and the non-magnetized magnets on an inner peripheral surface of the cylindrical rotary body to form an outer rotor structure for the motor rotor, and such that the placing of the magnetization yoke is concentrically within and inside of the cylindrical rotary body; or
placing the pre-magnetized magnets and the non-magnetized magnets in an axial flux pattern to form an axial flux rotor for the motor rotor.

11. The motor rotor made by the method of claim 1.

12. The motor rotor made by the method of claim 2.

13. The motor rotor made by the method of claim 3.

14. The motor rotor made by the method of claim 4.

15. The motor rotor made by the method of claim 5.

16. The motor rotor made by the method of claim 6.

17. The motor rotor made by the method of claim 7.

18. The motor rotor made by the method of claim 8.

19. The motor rotor made by the method of claim 9.

20. The motor rotor made by the method of claim 10.
